(19) United States
(12) Patent Application Publication
(10) Pub. No.: US 2017/0275141 A1
(43) Pub. Date: Sep. 28, 2017

(54) Method for Efficient Power Plant Maintenance

(71) Applicant: Greg Weston, La Conner, WA (US)

(72) Inventor: Greg Weston, La Conner, WA (US)

(21) Appl. No.: 15/608,225

(22) Filed: May 30, 2017

Related U.S. Application Data
(60) Provisional application No. 62/382,135, filed on Aug. 31, 2016.

(51) Int. Cl. B66C 17/26; G21D 3/04; G21C 7/36

(52) U.S. Cl. CPC B66C 17/26; G21C 7/36; G21D 3/04; B66C 17/00

(57) ABSTRACT

Methods for nuclear power plant maintenance which reduces outage time while a polar crane is maintained. In some examples, the method includes the steps of placing an auxiliary crane on a set of rails of a polar crane, using the auxiliary crane to perform maintenance work while the polar crane is maintained, and removing the auxiliary crane after maintenance work on the polar crane is completed. In some further examples, the method includes placing a second auxiliary crane on the set of rails. Still in other example, bridge motors are used to turn the rails, allowing the auxiliary crane to reach every area of the plant floor.

### CROSS REFERENCE TO RELATED APPLICATIONS

This application claims priority to copending U.S. Provisional Application, Serial No. 62382135, filed on Aug. 31, 2016, which is hereby incorporated by reference for all purposes.

### BACKGROUND

The present disclosure relates generally to nuclear power plant maintenance procedures. In particular, methods for reducing outage time of nuclear power plants during routine maintenance and while a polar crane is maintained by continuing utilization of a bridge and supplemental crane are described.

Nuclear power plants play an essential role in the US power grid system. With nearly 20% of all power in the US coming from nuclear power, it is vital that these plants continue to operate safely and efficiently. To ensure that US nuclear power plants are safe and efficient, routine maintenance is performed on the plants, on average, every 18 or 24 months. This maintenance is called a refueling outage.

During a refueling outage, a specific reactor is shut down in order to replace spent or used fuel rods. In this process, a reactor head is removed, the fuel rods are removed from that reactor's core, and specific fuel rods are replaced and shuffled around to ensure an even distribution of heating. Also during an outage and while the reactor is shut down, other plant maintenance is performed. Valves are checked, lines are inspected, and facilities are maintained. Included in this maintenance is inspection, repair, and replacement of the plant's polar crane.

A polar crane is a large crane positioned in the top of a circular containment unit in nuclear power plants. A polar crane is used in typical plant maintenance and operational functions. The hoist is mounted on a trolley that is positioned between two bridge girders. Because it is on rails, the trolley and hoist are able to move horizontally back and forth along the rails. These rails and bridge girders are in turn supported by the walls of the containment unit itself and are positioned on a track that runs around the circumference of the circular containment unit. With the two bridge girders positioned on the circular track, the rails can rotate in a circular motion around the entire containment unit. Because the trolley and hoist are positioned on the girders, and the girders are positioned on a circular track, the crane is able to move and rotate to reach every part of the containment floor below it with a hook. The crane is operated by an operator from a cab that is positioned on the trolley or on the bridge girders above the crane hook.

Current methods for maintaining a nuclear power plant and a polar crane during a refueling outage are not entirely satisfactory for the range of applications in which they are employed. For example, existing methods for polar crane maintenance during a refueling outage extends the time of the refueling outage. If the polar crane or components of the polar crane need maintenance or replacing during a refueling outage, all lifting and other floor maintenance that depends on the use of the polar crane must cease. Without an operational polar crane, maintenance on the floor of the containment unit cannot be performed simultaneously with the polar crane maintenance. As a result, the total time of the refueling outage is extended based on the time the polar crane is not operational. This extension of refueling outage time costs the nuclear power plant millions in lost revenue and increased operational expenses.

Thus, there exists a need for nuclear power plant maintenance methods that improve upon and advance the current methods for nuclear power plant maintenance. Examples of new and useful methods relevant to the needs existing in the field are discussed below.

### SUMMARY

The present disclosure is directed to a method for nuclear power plant maintenance which reduces outage time while a polar crane is maintained. In some examples, the method includes the steps of placing an auxiliary crane on a set of rails of a polar crane, using the auxiliary crane to perform maintenance work while the polar crane is maintained, and removing the auxiliary crane after maintenance work on the polar crane is completed.

In other examples, the method for nuclear power plant maintenance includes the steps of lifting an auxiliary crane onto a set of rails of an operating polar crane, shutting down operations of the polar crane and maintaining the polar crane, using the auxiliary crane for floor maintenance operations in place of the polar crane, restarting operations of the polar crane after maintenance of the polar crane is complete, and removing and lowering the auxiliary crane from the set of rails of the operating polar crane.

In this example of the method, the step of lifting the auxiliary crane onto a set of rails of an operating polar crane may further include placing the auxiliary crane at an end of the rails opposite a cab of the polar crane. The auxiliary crane may then operate on at least one half of the set of rails opposite the cab of the polar crane. Further in this example of the method, the bridge motors may continue to operate the bridge and rotate the set of rails. Doing this allows the auxiliary crane to operate on the one half of the set of rails opposite the cab of the polar crane to reach an entire area of a floor of a nuclear power plant.

Further in this example of the method, the step of lifting an auxiliary crane onto a set of rails of an operating polar crane may include the step of lifting a second auxiliary crane onto the set of rails. When a second crane is lifted onto the rails, temporary controls may be connected to a bridge's bridge motors. Using the temporary controls, a user may operate the bridge motors to rotate the bridge and the set of rails. In these examples of the method, the auxiliary crane is a small, self-erecting boom crane.

In order to lift the auxiliary crane onto the set of rails of the operating polar crane, ropes or cables may be attached to a bridge of the polar crane. Then, the small, self-erecting boom crane is attached to the ropes or cables so that the small, self-erecting boom crane may climb the ropes or cables. Next, the small, self-erecting boom crane is placed on the set of rails.

In other examples of the method for nuclear power plant maintenance, the method may include the steps of disassembly, unload shuffle reload, and reassembly. The step of disassembly includes disassembling a core reactor using a polar crane, then attaching ropes or cables to a bridge of the polar crane. A small, self-erecting boom crane is then attached to the ropes or cables which then climbs the ropes or cables to the bridge. The self-erecting boom crane is then set on the bridge. Using the small, self-erecting boom crane, a larger knuckle boom crane is lifted and set on the bridge. Using the small, self-erecting boom crane again, a man basket and tooling and equipment is lifted.

Further included in this method, the step of unload shuffle reload includes shutting down the polar crane operations and connecting temporary controls to bridge motors. The temporary controls allow continued use of the bridge so that the small boom crane and larger knuckle boom crane can continue floor and polar crane maintenance operations. Further, half of the bridge motors are shut down for maintenance while the other half of the bridge motors control the bridge. After the first half of the bridge motors are maintained, they are returned to operation and the unmaintained motors are shut down for maintenance. After placing contaminated equipment in sealed containers, the polar crane and bridge motors are restarted and the temporary controls are disconnected.

Still further included in this method, the step of reassembly includes using the small, self-erecting boom crane to lower tooling and equipment and the man basket. Then the small, self-erecting boom crane lowers the larger knuckle boom crane. The small, self-erecting boom crane is next disconnected from the bridge and lowered down the ropes or cables. The ropes or cables are then removed from the bridge. Finally, the polar crane is returned to full operation and used to reassemble the core reactor.

### BRIEF DESCRIPTION OF THE DRAWINGS

FIG. 1 is a perspective view of an example of a polar crane used in a nuclear power plane.

FIG. 2 is a flow chart of a first example of a method for nuclear power plant maintenance which reduces outage time while a polar crane is maintained

FIG. 3A is a flow chart of a second example of a method for nuclear power plant maintenance which reduces outage time while a polar crane is maintained, depicting the step of disassembly.

FIG. 3B is a continuation of the flow chart of the second example of the method shown in FIG. 3A, depiction the step of unload, shuffle, reload.

FIG. 3C is a continuation of the flow chart on the second example of the method shown in FIGS. 3A and 3B, depicting the step of reassembly.

### DETAILED DESCRIPTION

The disclosed methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of method examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

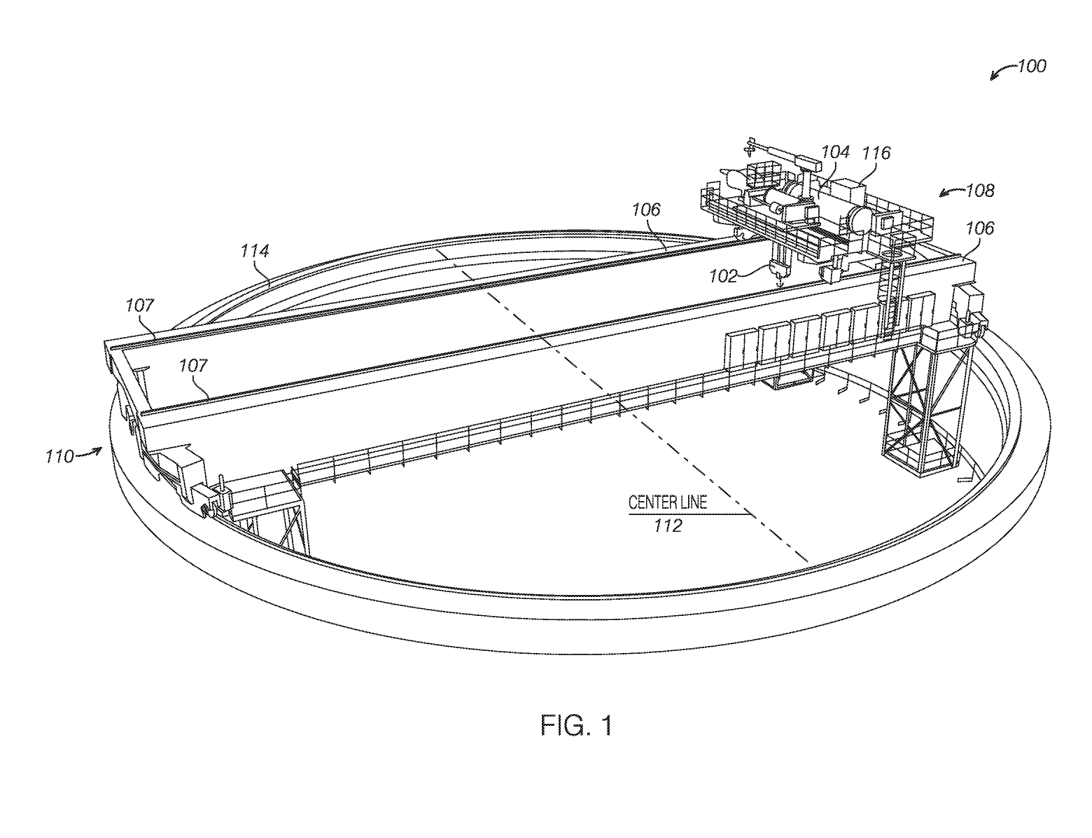

With reference to FIG. 1, an example of a polar crane 100 utilized in the invention will now be described. Polar crane 100 is an example of a typical polar crane found in a containment unit of nuclear power plants. It functions to lift and support operations on the floor of the containment unit. Polar crane 100 is positioned in the top of a containment unit, such that most operations that necessitate a crane are below it.

As shown in FIG. 1, polar crane 100 includes a hoist 102, usually consisting of a hook and cable system, attached to a trolley 104. The trolley 104 is positioned perpendicular to and across two bridge girders 106. Trolley 104 has bridge wheels that sit on rails 107 that allows trolley 104 to move horizontally along rails 107. The wheels of trolley 104 allows it to move from a first side 108 across to a second side 110, crossing a center of the rails 107 and the containment unit represented be a center line 112. The center line 112 is representative of an approximate center of bridge girders 106 and center of the containment unit.

Further shown, the first side 108 and second side 110 of bridge girders 106 have rail wheels, said rail wheels resting on a track 114. The rail wheels supported by track 114 is circular and sits atop the walls of the containment unit housing polar crane 100 and a nuclear core. The rail wheels allow bridge girders 106 to turn in a complete circle along the perimeter track 114 of the containment unit. The circular rotation of bridge girders 106, along with the horizontal movement of trolley 104 along rails 107, allow the hoist 102 to access every part of the containment unit on the floor within track 114.

Still further shown in FIG. 1, a cab 116 is positioned on the first side 108 of bridge girders 106. The cab 116 houses the controls for polar crane 100, and is where an operator of polar crane 100 would sit. The controls for polar crane 100 control the hoist 102, and control bridge motors that control and move the trolley wheels and bridge wheels. An operator positioned in cab 116, using the controls, could position the hoist 102 carefully and precisely in order to perform tasks and maintenance necessary to help continue operations of the nuclear power plant.

When it becomes necessary for polar crane 100 to undergo maintenance or replacement, polar crane 100 must be shut down, and any floor maintenance requiring the use of polar crane 100 is halted. Not until polar crane 100 is fully functional once again can floor maintenance continue. This stoppage of floor maintenance while polar crane 100 is maintained or replaced can take many days, and has the potential to cost the power plant millions in lost revenue and increased operating costs. The methods described below provide a way to continue floor maintenance using a crane while simultaneously performing polar crane 100 maintenance.

A first embodiment of the method is comprised of placing at least one auxiliary crane on the bridge girders 106 of polar crane 100 and using the auxiliary crane to continue lifting and floor maintenance while polar crane 100 is maintained or replaced. After maintenance is completed on polar crane 100, the auxiliary crane is removed from bridge girders 106, and polar crane 100 continues operations as normal.

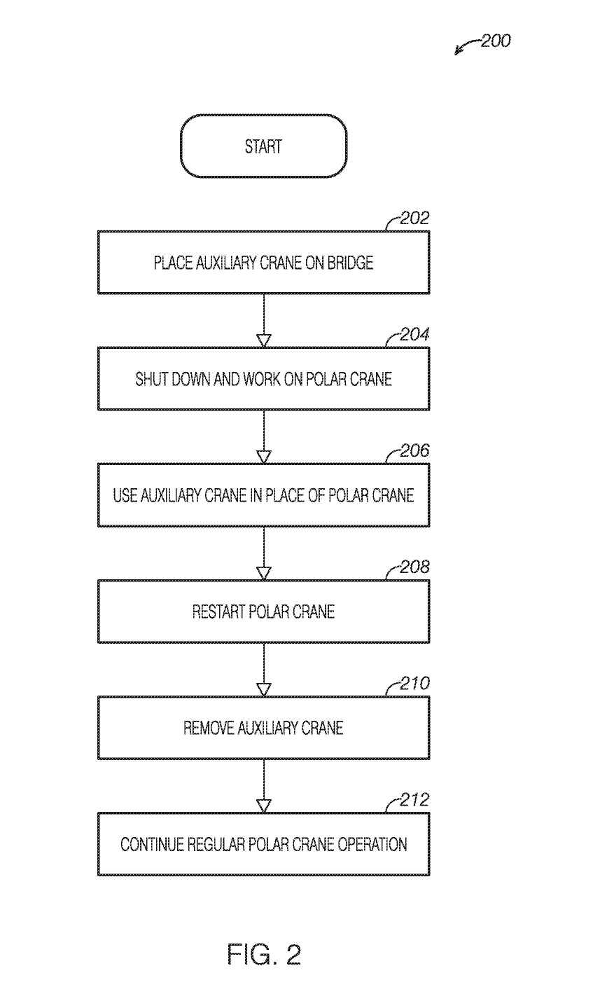

With reference to FIG. 2, another embodiment with more detail, method 200 for improved nuclear power plant maintenance procedures will now be described. In step 202, an auxiliary crane is lifted and positioned on the bridge or rails 107 of polar crane 100, preferably on second side 110, opposite of cab 116. In step 204, operations of polar crane 100 are shut down, and maintenance is performed on polar crane 100. In step 206, while polar crane 100 is shut down and maintained, the auxiliary crane is used in place of polar crane 100 to continue maintenance and lifting on the rest of the containment unit. Included in this step, the bridge motors continue to operate in some capacity to rotate the bridge girders 106. In step 208, after maintenance is completed, the polar crane 100 is restarted. In step 210, the auxiliary crane is removed from the bridge girders 106 of polar crane 100. In step 212, normal operations of polar crane 100 continue.

This embodiment of the method is beneficial because floor maintenance requiring use of a crane can continue while the main polar crane 100 is maintained or replaced. This allows for a shorter refueling outage than would normally be possible because there would be no time lost to maintaining polar crane 100. Simultaneous floor work requiring use of a crane could continue despite the polar crane 100 being inoperable during maintenance. In addition, through the use of the bridge motors, the auxiliary crane placed on bridge girders 106 is capable of reaching the entirety of the containment floor.

Despite polar crane 100 remaining on bridge girders 106 and utilizing up to half of the rails 107, the auxiliary crane is still capable of reaching the entire containment floor to perform any required or scheduled maintenance work. With the auxiliary crane placed opposite of cab 116, the auxiliary crane can use all of the second side 110 opposite cab 116 on first side 108, across center line 112. Because the auxiliary crane can utilize all of second side 110, and even some of the first side 108, and bridge girders 106 can rotate completely around, auxiliary crane can reach any part of the containment floor. Thus, the auxiliary crane can continue any necessary floor maintenance while polar crane 100 is simultaneously maintained.

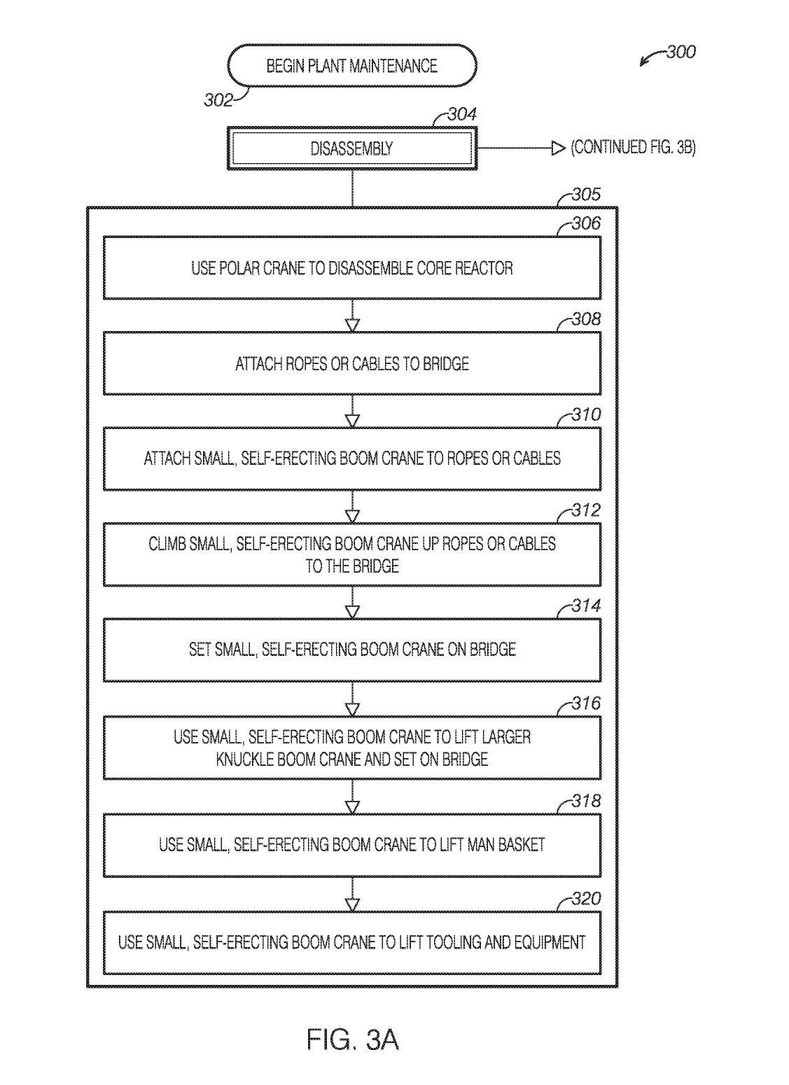

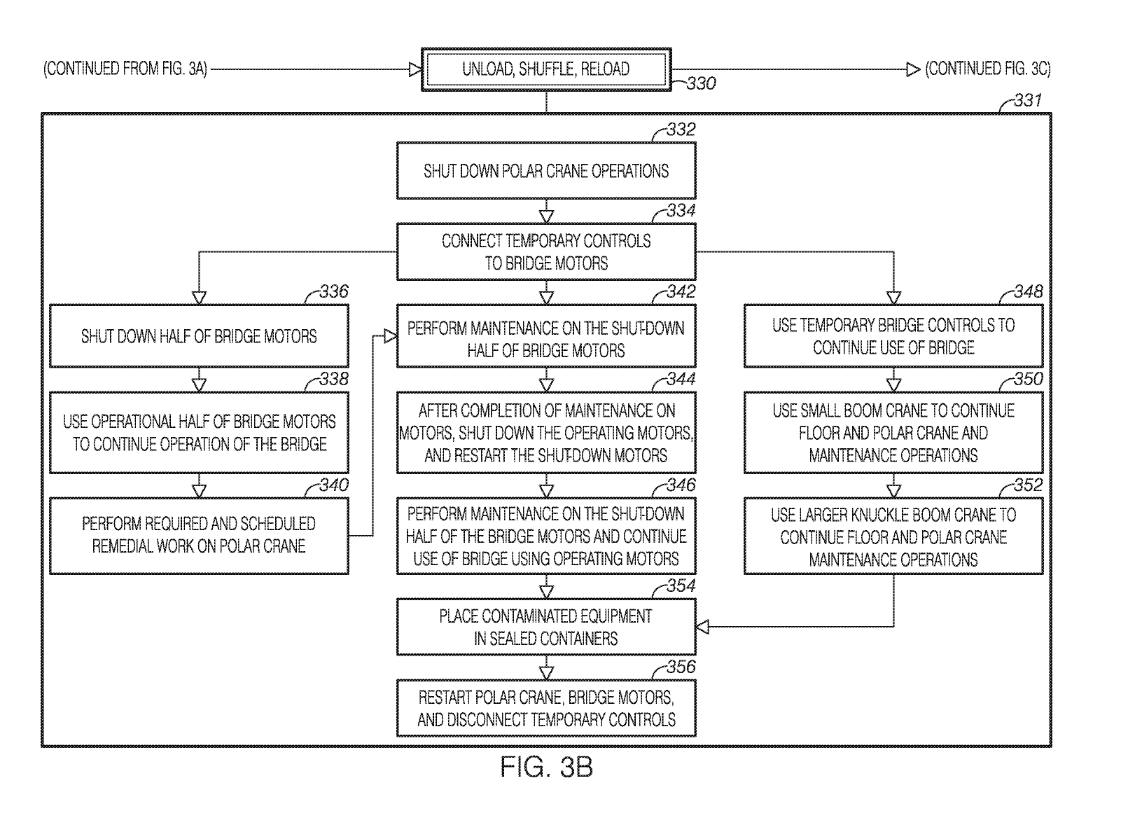

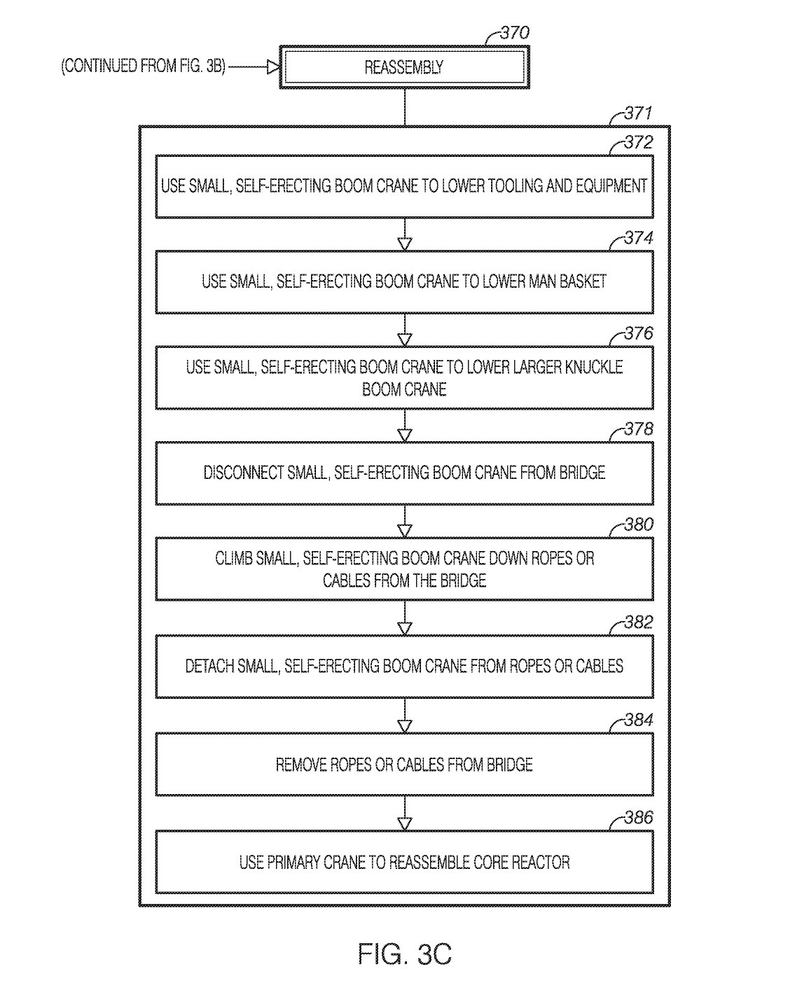

With reference to FIGS. 3A-3C, a third embodiment with even greater detail, method 300 for improved nuclear power plant maintenance procedures will now be described. Referreng to FIG. 3A, step 302 is the beginning of plant maintenance. Included in step 302 is shutting down the nuclear power plant and preparing the core reactor for disassembly.

Still referring to FIG. 3A, in step 304, disassembly of the core reactor takes place and preparations are made for maintenance of the polar crane 100. Included in step 304 are a series of other disassembly steps 305. In step 306, the polar crane 100 disassembles the core reactor. In this embodiment, it is necessary that the polar crane 100 disassemble the core reactor first because other auxiliary cranes do not have the capacity to lift it. However, in alternate embodiments, auxiliary cranes would have the capability to lift and disassemble the core reactor.

As seen in FIG. 3A, in step 308, ropes or cables are attached to the bridge girders 106. The ropes or cables are preferably attached to the second side 110 of the bridge girders 106, opposite of cab 116 on first side 108. Step 308 marks the beginning of attaching an auxiliary crane to bridge girders 106. In step 310, a small, self-erecting boom crane is attached to the ropes or cables. The self-erecting boom crane then climbs up the ropes or cables to rails 107 in step 312. In step 314, the self-erecting boom crane is set on rails 107. At this point, the self-erecting boom crane is connected to a power source and is considered set up and operational. The self-erecting boom crane in this embodiment is set up on the second side 110 of the bridge girders 106, on the opposite side from cab 116.

As seen in FIG. 3A, still as part of disassembly steps 305 in step 304, step 316 uses the small self-erecting boom crane to lift a large knuckle boom crane and set it on rails 107. Again, preferably the larger boom crane is positioned on second side 110 on rails 107 opposite from cab 116. The larger boom crane is connected to a power source and is considered set up and operational. In an alternate embodiment, the large knuckle boom crane is not needed, and is not lifted, skipping step 316. In step 318, the small self-erecting boom crane is used to lift a man basket. In an alternate embodiment, the large knuckle boom crane is used to lift the man basket. Still in another embodiment, the man basket is not necessary and is not lifted at all, and step 318 is skipped. In step 320, the small self-erecting boom crane is used to lift any tooling and equipment necessary. In an alternate embodiment, the large knuckle boom crane is used to lift the tooling and equipment. Still in another embodiment, the tooling and equipment are not necessary and step 320 is skipped.

The power source operating the small self-erecting boom crane and the large knuckle boom crane is provided, in this embodiment, by one or more temporary power assemblies placed on polar crane 100, and more preferably, on bridge girders 106. The source of power for the one or more temporary power assemblies includes a polar crane power source, or a source on the containment unit floor, where a cord connects the cranes and the power source.

In this embodiment, method 300 utilizes more than one crane to perform maintenance work. In this embodiment, one crane can be used to perform necessary maintenance on polar crane 100, and the other crane can be used to continue floor operations and lifting. Alternatively, both cranes may be utilized for polar crane 100 maintenance or floor maintenance and lifting. In this embodiment, a small self-erecting boom crane and a large knuckle boom crane are used. However, any type and combination of crane can be used to perform the necessary maintenance.

With a small self-erecting boom crane and large knuckle boom crane on rails 107 and connected to a power source, step 304 is complete. Now turning to FIG. 3B, and as can be seen in step 330, unloading, shuffling, and reloading of core rods in the core reactor takes place. Additionally, and included in step 330, there are a series of other load, shuffle, reload steps 331 that focus on maintenance. In step 332, with the small self-erecting boom crane and large knuckle boom crane in position on bridge girders 106 and opposite cab 116, the polar crane 100 is shut down. While polar crane 100 is shut down, temporary controls are connected to control bridge motors. These temporary controls will control the motors for the bridge allowing the bridge girders to continue to turn completely around along the perimeter track 114. While the polar crane 100 is shut down, and temporary controls in place, two series of steps occur simultaneously. A first series of steps describes maintenance of polar crane 100, while a second series of steps describes floor maintenance.

As shown in FIG. 3B, the first series of steps describes steps taken to perform scheduled maintenance of polar crane 100. In step 336, half of the bridge motors are shut down. At the same time in step 338, an operational half of the bridge motors are used to continue operations of the bridge and rails. A power source operating the bridge motors is provided, in this embodiment, by one or more temporary power assemblies placed on polar crane 100, and more preferably, on bridge girders 106. The source of power for the one or more temporary power assemblies includes a polar crane power source, or a source on the containment unit floor, where a cord connects the cranes and the power source. In step 340, required and scheduled maintenance is performed on the polar crane as it is shut down. In step 342, required and scheduled maintenance is performed on the half of bridge motors that are shut down.

Shutting down only half of the motors at a time allows for floor maintenance work to continue. Through the use of the operational half of the bridge motors, the small self-erecting boom crane and the large knuckle boom crane placed on bridge girders 106 are capable of reaching the entirety of the containment floor while simultaneously maintaining or replacing polar crane 100. The small self-erecting boom crane and the large knuckle boom crane use all of the second side 110 opposite cab 116 on first side 108, across center line 112, and rotate around on bridge girders 106, to fully access the containment floor for continued maintenance.

Still referring to FIG. 3B, after maintenance is performed on the shut-down half of the bridge motors, in step 344, the shut-down half of the motors are made operational again, and the previously operational half of motors are shut down. In step 346, required and scheduled maintenance is performed on the half of bridge motors that are now shut down. The operational half of the bridge motors are used to continue operations of the bridge.

In a similar fashion as previously described, shutting down only half of the motors at a time allows for floor maintenance work to continue. Through the use of the operational half of the bridge motors, the small self-erecting boom crane and the large knuckle boom crane placed on rails 107 are capable of reaching the entirety of the containment floor while simultaneously maintaining or replacing polar crane 100. The small self-erecting boom crane and the large knuckle boom crane use all of the second side 110 opposite cab 116 on first side 108, across center line 112, and rotate around on bridge girders 106, to fully access the containment floor for continued maintenance.

As shown in FIG. 3B, the second series of steps describes steps taken to continue scheduled maintenance on the floor of the containment unit. These second series of steps occur in conjunction with the first series of steps as previously described. In step 348, the temporary controls are used to control the operation half of motors from the first series of steps. In step 350, the small boom crane is used to continue maintenance both on the floor of the containment unit by lifting any necessary components, and on polar crane 100. In step 352, the large knuckle boom crane is used to also continue maintenance on both the floor of the containment unit by lifter any necessary components that are too large for the small boom crane to lift, and on polar crane 100.

Still referring to FIG. 3B and now FIG. 3C, at any time during steps 330 and 370 step 354 is performed. For convenience, step 354 is shown as included in step 330. In step 354, any contaminated parts and equipment are placed in sealed containers such that removal outside of the containment unit does not raise radiological concerns. In step 356, the polar crane, bridge, and bridge motors are put into operation, and the temporary controls are disconnected. At this point, maintenance of polar crane 100 is complete.

After maintenance has been completed on the polar crane 100 and it is once again fully operational, step 330 is complete. Now turning to FIG. 3C, in the next step 370, reassembly of the core reactor takes place. Additionally, and included in step 370, there are a series of other reassembly steps 371 that focus on the disassembly of the auxiliary crane or cranes.

As seen in FIG. 3C, in step 372, the small self-erecting boom crane is used to lower any tooling and equipment used in the maintenance of polar crane 100. In an alternate embodiment, the large knuckle boom crane is used to lower the tooling and equipment. Still in another embodiment, the tooling and equipment was not necessary and step 372 is skipped. In step 374, the small self-erecting boom crane is used to lower a man basket used in the maintenance of polar crane 100. In an alternate embodiment, the large knuckle boom crane is used to lower the man basket. Still in another embodiment, the man basket was not necessary and step 318 is skipped. In step 376, the small self-erecting boom crane is used to lower the large knuckle boom crane from the rails 106 to the floor of the containment unit to be removed. In steps 378 and 380, the small boom crane is disconnected from the bridge girders 106 and lowers itself to the floor of the containment unit using hanging ropes or cables to be removed from the containment unit. The ropes or cables are then removed from the bridge girders 106 in step 384. Finally, in step 386, the polar crane is used to reassemble the core reactor.

With polar crane 100 maintained and fully operational, it is ready to continue regular operations. Polar crane 100 can continue to lift and perform maintenance operations on the containment floor as normal. Polar crane 100 can also reassemble the core reactor.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for nuclear power plant maintenance which reduces outage time while a polar crane is maintained, the method comprising the steps of:
placing an auxiliary crane on a set of rails of a polar crane;
using the auxiliary crane to perform maintenance work while the polar crane is maintained; and
removing the auxiliary crane after maintenance work on the polar crane is completed.

2. A method for nuclear power plant maintenance which reduces outage time while a polar crane is maintained, the method comprising the steps of:
lifting an auxiliary crane onto a set of rails of an operating polar crane;
shutting down operations of the polar crane and maintaining the polar crane;
using the auxiliary crane for floor maintenance operations in place of the polar crane;
restarting operations of the polar crane after maintenance of the polar crane is complete;
removing and lowering the auxiliary crane from the set of rails of the operating polar crane.

3. The method of claim 2, wherein the step of lifting the auxiliary crane onto a set of rails of an operating polar crane further comprises placing the auxiliary crane at an end of the rails opposite a cab of the polar crane.

4. The method of claim 3, wherein the auxiliary crane operates on at least one half of the set of rails opposite the cab of the polar crane.

5. The method of claim 4, further comprising the step of continuing operation of bridge motors to operate the bridge and rotate the set of rails, such that the auxiliary crane can operate on the at least one half of the set of rails opposite the cab of the polar crane to reach an entire area of a floor of a nuclear power plant.

6. The method of claim 2, wherein the step of lifting an auxiliary crane onto a set of rails of an operating polar crane further comprises lifting a second auxiliary crane onto the set of rails.

7. The method of claim 2, further comprising the steps of:
connecting temporary controls to a bridge's bridge motors and using the temporary controls to operate the bridge motors to rotate the bridge and the set of rails.

8. The method of claim 2, wherein the auxiliary crane is a small, self-erecting boom crane.

9. The method of claim 2, wherein the step of lifting an auxiliary crane onto a set of rails of an operating polar crane comprises:
attaching ropes or cables to a bridge of the polar crane;
attaching the small, self-erecting boom crane to the ropes or cables;
the small, self-erecting boom crane climbing the ropes or cables; and
setting the small, self-erecting boom crane on the set of rails.

10. A method for nuclear power plant maintenance which reduces outage time while a polar crane is maintained, the method comprising the steps of:
disassembly, unload shuffle reload, and reassembly, where the step of disassembly includes;
disassembling a core reactor using a polar crane, attaching ropes or cables to a bridge of the polar crane and attaching a small, self-erecting boom crane to the ropes or cables and having the small, self-erecting boom crane climb the ropes or cables to the bridge, setting the self-erecting boom crane on the bridge, using the small, self-erecting boom crane to lift a larger knuckle boom crane and setting it on the bridge, and using the small, self-erecting boom crane to lift a man basket and tooling and equipment;
the step of unload shuffle reload includes;
shutting down the polar crane operations and connecting temporary controls to bridge motors, where the temporary controls allow continued use of the bridge so that the small boom crane and larger knuckle boom crane can continue floor and polar crane maintenance operations, and
Shutting down half of the bridge motors for maintenance while the other half of the bridge motors control the bridge, and after the half of the bridge motors are maintained, returning them to operation and shutting down the unmaintained motors for maintenance, and
placing contaminated equipment in sealed containers and restarting the polar crane and bridge motors and disconnecting the temporary controls;
the step of reassembly includes;
using the small, self-erecting boom crane to lower tooling and equipment and the man basket, using the small, self-erecting boom crane to lower the larger knuckle boom crane, disconnecting the small, self-erecting boom crane from the bridge and lowering it down the ropes or cables, removing the ropes or cables from the bridge, and using the polar crane to reassemble the core reactor.
